(19) United States
(12) Patent Application Publication
(10) Pub. No.: US 2025/0141990 A1
(43) Pub. Date: May 1, 2025

(54) METHOD AND SYSTEM FOR EFFICIENTLY TRANSMITTING SOME INFORMATION LOCATED IN A SCENE

(71) Applicant: Orange, Issy-Les-Moulineaux (FR)

(72) Inventors: Zhihong GUO, Beijing (CN); Li JIANG, Beijing (CN)

(21) Appl. No.: 19/006,690

(22) Filed: Dec. 31, 2024

Related U.S. Application Data
(63) Continuation of application No. PCT/IB2023/000409, filed on Jun. 26, 2023.

(30) Foreign Application Priority Data
Jul. 1, 2022 (WO) PCT/CN2022/103366

(51) Int. Cl. H04M 1/72439; G06V 10/26; G06V 20/70; G06V 30/148; G06V 30/196; H04M 1/72436

(52) U.S. Cl. CPC H04M 1/72439; G06V 10/273; G06V 20/70; G06V 30/155; G06V 30/1983; H04M 1/72436; G06V 2201/09; H04M 2250/52

(57) ABSTRACT

A method for efficiently transmitting some information located in a scene, suitable in particular to allow identification of the place of the scene, the method including the following: detecting some information of interest within the photo of the scene, where the information of interest comprises a logo, using a first mobile terminal; converting the information of interest into a string of characters, where the string of characters includes at least one character which represents geometrically the logo, using the first mobile terminal; and inserting the string of characters into a text message, to be sent from the first terminal to a second mobile terminal.

### CROSS-REFERENCE TO RELATED APPLICATIONS

This application is a Continuation application of PCT/IB2023/000409 entitled “METHOD AND SYSTEM FOR EFFICIENTLY TRANSMITTING SOME INFORMATION LOCATED IN A SCENE” and filed Jun. 26, 2023, and which claims priority to PCT/CN2022/103366 filed Jul. 1, 2022, each of which is incorporated by reference in its entirety.

### BACKGROUND

### Field

The present development relates to method and system for efficiently transmitting some information located in a scene, suitable in particular to allow identification of a given place. A typical application of the development is that of the delivery of goods.

### Description of the Related Technology

As one is making an order online, the buyer who purchased a product needs to define the location where he/she wants to receive the package. In some regions of the world (e.g., Middle East and Africa), there is no address for some places, so that the buyer has no way to describe the address of his/her home. Some customers will take a photo of a landmark near the home (i.e., a restaurant or a pharmacy near his/her home) and share the photo to the delivery man, then the delivery man should download the picture of the place, and try to meet the buyer at time.

However, it is not uncommon in these same regions that parts of the people there use low-end terminals or feature phones and only have access to 2G network. Receiving a picture would be too data traffic consuming, too expensive for them or even impossible.

There exist techniques which allow encoding an image with ascii text.

An example of such a technique can be performed through the following web tool: https://asciiart.club/.

These conversions however result in arbitrary long texts, with no information easily readable by a user.

On the other hand, U.S. Pat. No. 9,143,638B2 describes a portal scanner which employ an OCR feature in order to scan text and trademark symbols. More precisely, this portal scanner uses an algorithm to find a trademark logo in a scanned image and, when it has found such a logo, compares this logo with each one of a list of pre-stored logos in its on-board library. When it found a match between the detected logo and one pre-stored logo in its on-board library, it retrieves from its on-board library a pre-stored trademark alphanumeric code associated with the matching pre-stored logo, and transmits this trademark alphanumeric logo code instead of transmitting the whole image of the trademark logo.

Besides being highly computational demanding, as it requires systematic comparison of a detected logo with each pre-stored logo in an on-board library, such a process relies on a limited amount of pre-defined associations of trademark logo with respective trademark alphanumeric codes and thus cannot deal with scanned trademark logos which are not already pre-stored in the on-board library.

Besides, when a recipient user receives the trademark alphanumeric code, they do not have a clear knowledge about what the initial trademark logo really looks like and thus are not able to recognize it, which may be problematic especially in case where the recipient user needs to recognize this logo in order to find an address, as previously explained. In other words, the comprehensiveness of an information on a location place, such as logo identifying this location place, is substantially reduced when using this process, to the point where this information may not be useable any longer for its intended purpose.

Therefore, there is a need for a solution which allow sharing information such as a logo on a location place, with limited data traffic while maintaining the comprehensiveness of this shared information.

### SUMMARY

To this end, according to one aspect, it is proposed a method for efficiently transmitting some information located in a scene, said method comprising the following steps:
detecting some information of interest within a photo of the scene, using a first mobile terminal, wherein said information of interest comprises a logo;
converting said information of interest into a string of characters, wherein said string of characters comprises at least one character which represents geometrically said logo, using said first mobile terminal; and
inserting the string of characters into a text message to be sent from the first mobile terminal to a second mobile terminal.

Such a method is particularly well suited for allowing identification of the place of the scene. Indeed, with such a method, the main information of a location image acquired may be transmitted with a text message such as a short text (SMS). A user just needs to take a picture of the logo he or she is close to. The system will then encode the picture into a text message with the simplified logo. This saves a lot of network traffic fee for the users comparing to sending images.

Complementary features of the method proposed are as follows:
the step of detecting information of interest within the photo of the scene comprises a detection of a region of interest within the photo, said region of interest including said information of interest;
the step of converting the detected information of interest comprises performing a logo detection algorithm on at least a part of the photo to convert said logo into said at least one character which represents geometrically said logo;
in a case where said information of interest comprises a text, the step of converting the detected information of interest comprises processing at least a part of the photo with an optical character recognition unit in order to extract said text into said string of characters;
in a case where said information of interest comprises both a logo and a text, the method further comprises determining a size ratio between said logo and said text and the step of converting the detected information of interest comprises performing a logo detection algorithm on at least a part of the photo to select a string of characters among a plurality of predefined string of characters based on the determined size ratio;
the characters which represent geometrically the logo are non-alphanumeric ASCII characters, and in particular non-alphanumeric ASCII characters chosen among “|”, “/”, “\”, “.”, “−”, “+” and “_”.

According to another aspect, the development proposes a mobile terminal for efficiently transmitting some information located in a scene, said mobile terminal comprising a processing unit configured to:
detect some information of interest within a photo of the scene, wherein said information of interest comprises a logo;
convert the detected information of interest into a string of characters, wherein said string of characters comprises at least one character which represents geometrically the logo; and
insert the string of characters into a text message to be sent to another mobile terminal.

The mobile terminal may further comprise a detection unit configured to detect at least a region of interest comprising information of interest within the photo.

The mobile terminal may also further comprise a logo conversion unit configured, when said information of interest comprises a logo, to convert said logo into said string of characters and/or an OCR unit configured, when said information of interest comprises a text, to extract said text into said string of characters. In an advantageous embodiment, the characters which represent geometrically the logo are non-alphanumeric ASCII characters, in particular non-alphanumeric ASCII characters chosen among “|”, “/”, “\”, “.”, “−”, “+” and “_”.

Further according to another aspect, the development also proposes a system for efficiently transmitting some information located in a scene, said system comprising
at least a first mobile terminal useable by a first end user who needs to send information,
at least a second terminal useable by a second end user who is to receive this information,
a server able to exchange with first and second mobile terminals,
wherein said first and second mobile communication terminals and/or the server are configured to implement the following steps:
   detecting some information of interest within a photo of the scene, using said first mobile terminal, wherein said information of interest comprises a logo;
   converting the detected information of interest into a string of characters, wherein said string of characters comprises at least one character which represents geometrically the logo, using said first mobile terminal;
   inserting the string of characters into a text message;
   sending said text message from the first terminal to the second mobile terminal; and
   displaying said text message on said second mobile terminal.

Further, according to another aspect, it is proposed a computer program product, comprising code instructions for executing all or part of the steps of the method proposed, when the program is executed by at least a processing unit of a first and/or a second terminal and/or by at least a server of a system according to the development.

Also, it is further proposed a computer-readable medium, on which is stored a computer program product comprising code instructions for executing all or part of the steps of the method according to the development, when the program is executed by at least a processing unit of a first and/or a second terminal and/or by at least a server of the system according to the development.

### BRIEF DESCRIPTION OF THE DRAWINGS

The above and other objects, features and advantages of this development will be apparent in the following detailed description of an illustrative embodiment thereof, which is to be read in connection with the accompanying drawings wherein:

FIG. 1 illustrates an example of architecture in which the method according to the development is performed;

FIG. 2 illustrates various steps of a possible implementation for the development; and

FIGS. 3a to 3d and FIGS. 4a to 4b illustrate with image examples various steps of a possible implementation.

### DETAILED DESCRIPTION OF CERTAIN ILLUSTRATIVE EMBODIMENTS

### General Architecture

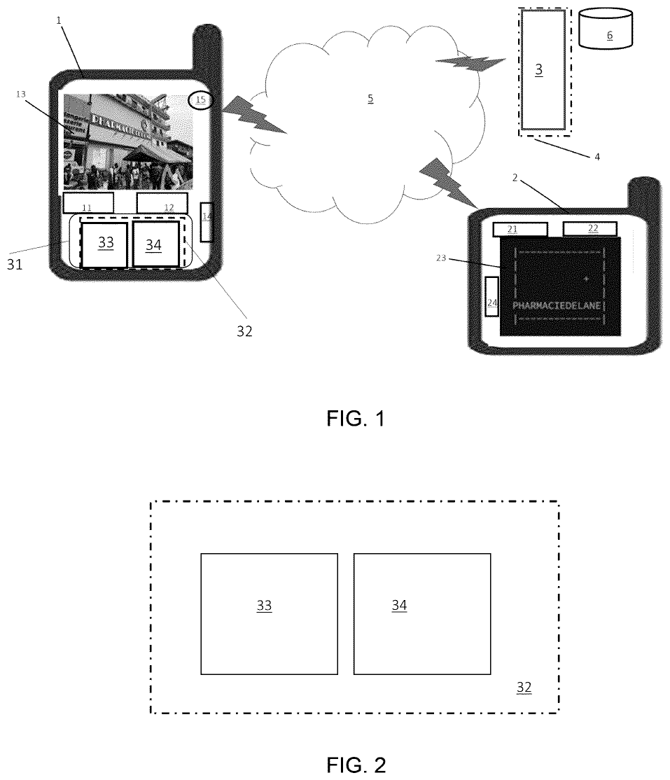

The system as represented on FIG. 1 comprises:
at least a first mobile communication terminal 1, used by a first end user (e.g., a buyer who needs to send information on where he is located),
at least a second communication terminal 2, used by a second an end user (e.g.: a delivery man who is to receive this information), and
an API 3 run on a server 4 and able to exchange with first and second mobile communication terminals 1 and 2 through a network 5 such as internet.

### Mobile Communication Terminals

First and second mobile communication terminals 1 and 2 can be of any type: e.g., computer, personal digital assistant, tablet, etc. They typically comprise a processing unit 11, 21, i.e., a CPU (one of more processors), a memory 12, 22 (for example flash memory) and a user interface which typically includes a screen 13, 23.

First and second mobile communication terminals 1 and 2 also comprise a communication unit 14, 24 for connecting (in particular wirelessly) said terminals 1 and 2 to a network (for example WiFi, Bluetooth, and preferably a mobile network, in particular a GSM/UMTS/LTE network, see below), etc.

First mobile communication terminal 1 advantageously also comprises a camera 15 which allows to take pictures, in particular of scenes at the place where its end user is located.

Second communication mobile can be functionally very limited provided it has an interface to output a short text, such as a display screen (screen 23). It can also be any kind of terminal with access to text message, e.g., through 2G network. It can be a simple pager, a feature phone or a long-end terminal. The system can also comprise other kinds of terminals within the group of the second communication terminals, such as smartphones.

### Steps of a Proposed Method—Examples

API 3 manages the input/output exchanges with first and second mobile communication terminals 1, 2. First mobile communication terminal 1 comprises a mobile application 31 able to exchange with API 3, from the buyer side. Such an application 31 is typically downloaded by the end user.

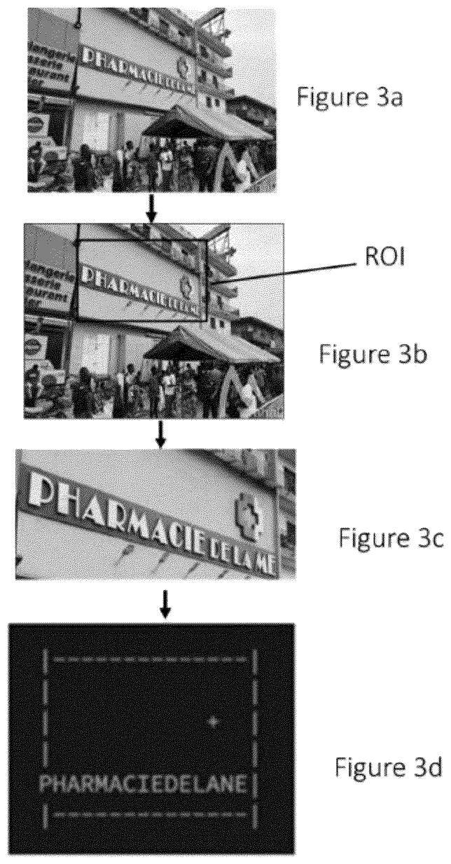

As illustrated on FIG. 1 and FIG. 2, said mobile application 31 includes a detection unit 32, which may comprise an OCR unit 33 and/or a logo conversion unit 34 as explained later.

Detection unit 32 allows to detect and extract information of interest within a given picture available in the first communication terminal 1, especially a picture captured by the user with camera 15 embedded within this first communication terminal 1.

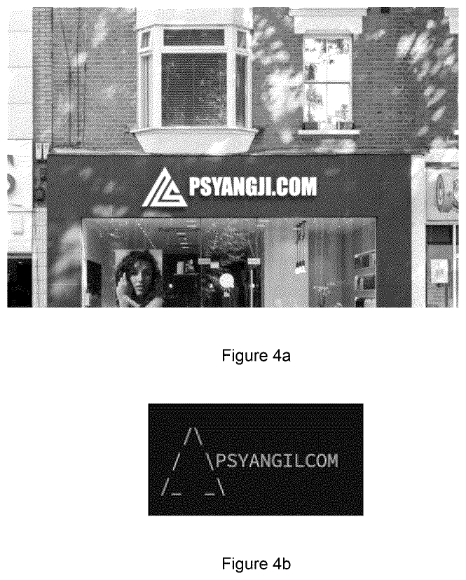

In a first example illustrated in FIGS. 3a to 3d, said picture is a photo of the scene of a place where an information of interest is to be efficiently transmitted by a first end user to a second end user, for instance a place where goods delivery is to take place, and is typically a photo of a scene of the place where the first end user is (e.g., FIG. 3a), this photo being captured by this first end user using their mobile terminal.

In a first embodiment, as a preliminary step, the detection unit 32 may advantageously detect one or more region(s) of interest, which contains information of interest, in the photo of the scene and extract a sub-image for each corresponding region of interest. A region of interest would typically be a sub-area of the picture where a logo or name of a store appears (zone within the frame represented on FIG. 3b). By doing so, the later described processes of extracting text and converting logos in strings of characters can be performed only on the extracted sub-image(s) rather than on the whole picture, which is helpful in decreasing the memory consumption and algorithm efficiency.

To this end, the detection unit 32 can provide the user with a selection tool which allows said user to identify and select on the picture a given area which he/she believes bears useful information. By way of example, the application can display a selection frame (e.g., the ROI frame on FIG. 3b) that the user can adapt on the image in order to the select said region of interest.

As a more automatic alternative, detection unit 32 can be programmed to implement a logo detection algorithm. Logo detection algorithms are classical tools which allow to detect and extract, within a received picture, regions of interest which are likely to contain logo and more generally texts. Typical tools for logo detection and extraction tools can use Convolutional Neural Networks. By way of example, a method for logo recognition based on CNN is described in the following publication: “Logo Recognition Using CNN Features”, Simone Bianco, Marco Buzzelli, Davide Mazzini, and Raimondo Schettini—Springer 2015—“https://link.springer.com/content/pdf/10.1007/978-3-319-23234-8_41.pdf”.

Once the region(s) of interest ROI is/are detected and its/their corresponding sub-image(s) extracted (FIG. 3c), the corresponding sub-image(s) (or alternatively the whole image when no region of interest is detected in a preliminary step) may be processed by a OCR unit 33 to extract text in said (sub) images and/or by a logo conversion unit 34 to determine if there is a logo in said (sub) images. Both OCR unit 33 and logo conversion unit 34 may be implemented as algorithms performed through program instructions executed by processing unit 11 of mobile terminal 1.

In other words, a step of converting the detected information of interest into a string of characters is performed wherein, when the detected information of interest comprises a logo, the resulting string of characters comprises one or more characters which represent geometrically this logo. These characters representing the logo may form only a part of this string of characters (for instance when there is also some text detected in the information of interest, to be inserted in the resulting string of characters). In other cases, the resulting string of characters may consist exclusively of one or more characters which represent geometrically the logo, for instance when the detected information of interest only includes a logo, without any other useful information.

OCR unit 33 can use any type of optical character recognition tool which converts image into text.

Logo conversion unit 34, which may implement a logo detection algorithm as explained above, detects if there is a logo in the image (or region of interest ROI within this image) and, when it is the case, converts this detected logo into a basic figure which corresponds to this logo. This basic figure is encoded in a string of one or more characters, such as ASCII characters, representing geometrically this logo. In the context of the present development, “representing geometrically a logo” means that:
either a single character can, on its own, represent geometrically a logo, such as in the example illustrated in FIGS. 3a to 3d, where the single character “+” is a representation of a cross logo detected in a pharmacy storefront;
or a plurality of characters are combined together, in such a way that they draw a figure whose shape substantially corresponds to the logo shape, at least sufficiently to enable a user to recognize the logo when looking at these characters together.

Such characters can then be easily inserted in a text message, with a limited size when compared to an image of the logo, while keeping essentially the information about the shape of the logo.

In an advantageous embodiment, these characters representing geometrically a detected logo are non-alphanumeric ASCII characters, which are easy to distinguish from other alphanumeric ASCII characters in a text message and are more adapted to represent geometrical shapes than letters or numbers. In particular, non-alphanumeric ASCII characters such as “|”, “/”, “\”, “.”, “−”, “+” and “_” are preferably used for representing geometrically a detected logo, since the shape of these specific non-alphanumeric ASCII characters is intrinsically better suited to form a graphical representation.

In an embodiment, pre-defined ASCII strings of characters, typically stored in a table, are associated with basic figures. For example, the basic figure “triangle” may be associated with a pre-defined ASCII string consisting of “\” and/or “/” and/or “−” and/or “ ”, such as:

[symbol]

This way, whenever the logo conversion unit 34 detects that the image (or the region of interest detected in this image) contains a logo with a substantial triangular shape, it retrieves the above pre-defined ASCII string of characters and outputs it as a result.

Similarly, a substantially rectangular logo can be converted in an ASCII string consisting of “|” and/or “−” and/or “ ”. Other basic figures (such as circle, cross, square, hexagon or rhombus, among others) can be predefined similarly in ASCII strings of characters, in order to be outputted whenever the logo conversion unit 34 detects a logo with a similar shape in the image (or a sub-image corresponding to a region of interest within the image).

In an advantageous embodiment, in order to process more complex types of logos, the logo conversion unit 34 uses an algorithm which divides the information of interest into grids, the size of each grid being defined by the size of character in the image. Then, for each of the grids containing a basic shape which is a part of a more complex logo, this basic shape is identified and may be converted into a specific string of characters representing this identified basic shape. Then, all the strings of characters representing respective basic shapes, retrieved on the basis of the identification of these basic shapes in the grids, can be gathered in the same text message, to represent geometrically this complex logo.

For instance, this algorithm may output a result as:
from line 1 to line 2, between column 5 and column 6: there is a diamond,
from line 2 to line 5, column 3 to 5: there is a Parallelogram,
from line 2 to line 5, column 5 to 8: there is another Parallelogram.

Based on these location and shape information, the algorithm can reproduce the complete logo with the corresponding string of characters (here a first string of characters representing a diamond and a second string of characters representing a parallelogram, used twice) placed together on the basis of their identified location.

When compared to an approach where a logo is systematically compared with each one of a list of pre-stored logos in a library, this approach is more dynamic and allows dealing with much more logos.

Typically, with the example of FIGS. 3c and 3d, the text within the ROI region “Pharmarcie de la Mer” is converted into ASCII characters, as is the cross just above the text of the name of the store (here with a single “+” character). And when output result is too long for a given size of text message to be displayed (for instance, 16 characters per line), the converted text may be truncated, as illustrated in FIG. 3d.

If in some cases more than one text string is detected in the region of interest, all text strings will be processed by OCR unit 33. If the total text number is more than a maximum number of characters (for instance 140 characters), the characters which are the furthest away from the center of interest area will be dropped. Similarly, if in some cases more than one logo is detected, all logos will be processed and converted into ASCII strings of characters by logo conversion unit 34 and, if the total length of the ASCII strings of characters is more than a maximum number of characters (for instance 140 characters), the characters which are the furthest away from the center of region of interest will be dropped.

In another example, as illustrated in FIGS. 4a-4b, when a logo associated with a text is detected in the photo (or within a region of interest of this photo), both OCR unit 33 and logo conversion unit 34 are used.

In particular, for each one of a series of basic figures, a subset of different ASCII strings of characters may be associated to different sizes of this basic figure. Taking again the example of a “triangle” figure, a subset comprising the two following ASCII strings may be predefined for this kind of basic “triangle” shape (though the development is not limited to two sizes, but may comprise more than two sizes predefined for each figure): a smaller triangle (defined on two lines):
[symbol] A larger triangle (defined on three lines):

[symbol]

Whenever a logo associated with a text is detected, the size of the text is determined, typically by the OCR unit 33 which identifies the height and width of the text area. The size of the logo is also determined, typically by the logo conversion unit 34 which identifies the shape of the logo (triangle, rectangle, etc.), its height and its width. Both sizes are then used to calculate a logo vs text size ratio, for instance by calculating a ratio between the height of the logo and the height of the text area. Thereafter, when selecting an ASCII string within the subset of several possible ASCII strings corresponding to the identified shape of the detected logo, the logo conversion unit 34 selects the ASCII string which, when compared to a text encoded on one line (as it will appear on the display of the receiving mobile communication terminal), provides the most similar size ratio to this calculated logo vs text size ratio.

For instance, when the picture contains a triangular logo which is approximately three times the size of an adjacent text as illustrated in FIG. 4a (i.e., ratio 3:1), the above-illustrated “larger triangle” ASCII string of characters (coded on 3 lines) is selected and outputted by the logo conversion unit 34, while the OCR unit 33 outputs the detected text, encoded on a single line.

Alternatively, the ASCII string representing the shape of the logo may be determined based on the location of text and shape of the logo. For example, if there is a text in a circle logo, then an ASCII representation with 5 lines of characters is preferably selected, as it is hard to show a text within an ASCII representation made of only 3 lines.

Both outputs may then be encoded together, in a relative position mostly similar to the original image (e.g., in FIG. 4b, the text being positioned on the right of the ASCII representation of the logo, next to the second line of this ASCII representation in order to be centered on it), resulting in an output which looks similar to the original image, but purely made of text/ASCII characters, as illustrated in FIG. 4b.

To do so, the OCR unit 33 can work out the coordinates of each point (top left, top right, bottom left, bottom right) defining the boundaries of the text area, while the logo recognition unit 34 can work out the coordinates of the logo area. Based on these coordinates, the relative location of text and logo can be determined, in order to finally display the text on top (north of), on left (on west of), on right (on east of, as illustrated in the example of FIG. 4b), on bottom of the logo (on south of) or in the middle of the logo (as illustrated in the example of FIG. 3d).

The OCR unit output and/or logo conversion unit output is an ASCII chain of characters which is transmitted to API 3 through network 5. API 3 includes an encoding unit 35 which encapsulates the chain of characters into a text message to be sent to the second communication terminal, this chain of characters being encapsulated within a given format, typically a 160 characters SMS message. Advantageously, when there is a limit for the total number of characters which can be displayed in one line (e.g., 16 characters maximum per line), if the total number of the chain of characters outputted in one line exceeds this limit, the text beyond this limit can be dropped. When the limitation on the total number of characters in one line can be changed dynamically, the encoding unit 35 can modify the output based on this limit.

As an alternative, encapsulation of the chain of characters can also be performed with first communication mobile 1.

API 3 may further exchange with other servers (data base 6) to identify the second communication mobile which is to receive the information.

The message thus prepared is then sent to said second communication mobile, where it can be displayed to the second end user. The second end user therefore has access to the chain of characters which bears the information liable to help him identify the place where the delivery is to take place.

As can be understood, the method and system described allow an efficient exchange of information, in particular of specific information allowing to identify the place where the delivery is to take place, with limited network use, in comparison with systems where full images are sent.

The method described above can be triggered after that a photo of the scene containing the information of interest has been captured using the first terminal (e.g., with an embedded camera of this first terminal), for instance by providing the user of this first terminal, on the display of this first mobile terminal, with an interface (such as a pop-up or icon) proposing to share efficiently information of interest located within the captured photo.

When the user activates such an interface displayed on the first mobile terminal, and after that this user has identified other user(s) with whom to share the information of interest (typically by selecting them in a contact list or entering their phone number), most or all of the above-described steps of detecting the information of interest (possibly involving the detection of a region of interest), converting this detected information of interest (logo and/or text) into a string of characters, inserting this string of characters into a text message and sending this text message to the other user(s) can be performed automatically, i.e., without further interaction of the user with the first mobile terminal.

### Example of Use

The method and system described can be used within mobile e-commerce solutions, e.g., with merchant websites which are to improve their business performance and customer satisfaction.

As already described, key information is extracted from a picture of the place where the delivery is expected. This key information is then sent by a short text message to the delivery man. The delivery man can compare the text and the shape of logo received in ASCII format with the view of the real place, to make sure if he/she reached the correct landmark.

This would be particularly adapted for Middle East and African countries where many people are limited in their phone exchanges capabilities as they use long-end terminals or feature phones and/or only have access to 2G network.

However, the present development is not limited merely to mobile e-commerce solution and can be used to efficiently transmit to a first user any relevant information captured by a second user with the camera of their mobile terminal (for instance information to be shared on a social media relying on short messages such as Twitter), without consuming too much network bandwidth or spending network traffic fee.

What is claimed is:

1. A method for efficiently transmitting some information located in a scene, the method comprising:
detecting some information of interest within a photo of the scene, using a first mobile terminal, wherein the information of interest comprises a logo;
converting the detected information of interest into a string of characters, wherein the string of characters comprises at least one character which represents geometrically the logo, using the first mobile terminal; and
inserting the string of characters into a text message to be sent from the first mobile terminal to a second mobile terminal.

2. The method according to claim 1, wherein detecting information of interest within the photo of the scene comprises a detection of a region of interest within the photo, the region of interest including the information of interest.

3. The method according to claim 1, wherein converting the detected information of interest comprises performing a logo detection algorithm on at least a part of the photo to convert the logo into the at least one character which represents geometrically the logo.

4. The method according to claim 1, wherein the information of interest comprises a text, and wherein converting the detected information of interest comprises processing at least a part of the photo with an optical character recognition unit in order to extract the text into the string of characters.

5. The method according to claim 1, wherein the information of interest comprises both a logo and a text, the method further comprising determining a size ratio between the logo and the text, wherein converting the detected information of interest comprises performing a logo detection algorithm on at least a part of the photo to select a string of characters among a plurality of predefined string of characters based on the determined size ratio.

6. The method according to claim 1, wherein the characters which represent geometrically the logo are non-alphanumeric ASCII characters.

7. The method according to claim 6, wherein the non-alphanumeric ASCII characters are chosen among “|”, “/”, “\”, “.”, “−”, “+” and “_”.

8. A mobile terminal for efficiently transmitting some information located in a scene, the mobile terminal comprising a processing unit configured to:
detect some information of interest within a photo of the scene, wherein the information of interest comprises a logo;
convert the detected information of interest into a string of characters, wherein the string of characters comprises at least one character which represents geometrically the logo; and
insert the string of characters into a text message to be sent to another mobile terminal.

9. The mobile terminal according to claim 8, wherein the mobile terminal further comprises a detection unit configured to detect at least a region of interest comprising information of interest within the photo.

10. The mobile terminal according to claim 8, wherein the mobile terminal further comprises a logo conversion unit configured to convert the logo into the string of characters and/or an OCR unit configured, when the information of interest comprises a text, to extract the text into the string of characters.

11. The mobile terminal according to claim 8, wherein the characters which represent geometrically the logo are non-alphanumeric ASCII characters, in particular non-alphanumeric ASCII characters chosen among “|”, “/”, “\”, “.”, “−”, “+” and “_”.

12. A system for efficiently transmitting some information located in a scene, the system comprising:
at least a first mobile terminal useable by a first end user who needs to send information,
at least a second terminal useable by a second end user who is to receive this information,
a server able to exchange with first and second mobile terminals,
wherein the first and second mobile communication terminals and/or the server are configured to implement the following:
detecting some information of interest within a photo of the scene, using the first mobile terminal, wherein the information of interest comprises a logo;
converting the detected information of interest into a string of characters, wherein the string of characters comprises at least one character which represents geometrically the logo, using the first mobile terminal;
inserting the string of characters into a text message;
sending the text message from the first terminal to the second mobile terminal; and
displaying the text message on the second mobile terminal.

13. The system according to claim 12, wherein the first mobile terminal includes a detection unit configured to detect at least a region of interest comprising information of interest within the photo.

14. The system according to claim 12, wherein the first mobile terminal includes a logo conversion unit configured to convert the logo into the string of characters and/or an OCR unit configured, when the information of interest comprises a text, to extract the text into the string of characters.

15. A non-transitory computer-readable storage medium on which is stored a computer program comprising program code instructions for executing all or part of the method according to claim 1, when the computer program is executed by at least a processing unit of a first and/or a second terminal and/or by at least a server of a system, wherein the at least a processing unit and/or the at least a server of the system is configured to:
detect some information of interest within a photo of a scene, wherein the information of interest comprises a logo;
convert the detected information of interest into a string of characters, wherein the string of characters comprises at least one character which represents geometrically the logo; and
insert the string of characters into a text message to be sent to another mobile terminal.
